(19) United States
(12) Patent Application Publication
(10) Pub. No.: US 2020/0060307 A1
(43) Pub. Date: Feb. 27, 2020

(54) Novelty items for foods on a stick or a cone

(71) Applicant: Charlene F. Chessum, Stockton, CA (US)

(72) Inventor: Charlene F. Chessum, Stockton, CA (US)

(21) Appl. No.: 15/496,125

(22) Filed: Apr. 25, 2017

(51) Int. Cl. A23G 9/50; B65D 85/78

(52) U.S. Cl. CPC A23G 9/503; B65D 85/78

(57) ABSTRACT

The present invention relates generally to food items on a stick and how to keep the sticky mess off the hands, arms and surrounding area of the one eating the food. Generally food items are served on a stick or in a cone without anything to catch the mess. When frozen treats are not eaten quickly enough the food items melts and runs down the hand and arm of the one eating it and will even drop on the surrounding area creating a sticky mess. Food items that have condiments on them sometimes are so heavy with condiments that they drip down on hands, arms and the surrounding area creating a mess. These novelty items allow the user to have fun creating unique fun items with their food while keeping the mess at bay. Flowers can be created with the food item being the Stamen and the container being the body of the flower and the petals. The food parts that drop off the food item would fall in the body of the flower and be contained there allowing the user to keep eating and not worry about the mess.

### BACKGROUND

There are several products designed for edible items on a stick or in a cone; however, most of them are not very much fun.

The problem with the current method is they are not fun; therefore, not used very often. They also are not easy to use because they are stiff or they are made out of a thin paper that gets saturated easily.

This invention relates generally to edible items on a stick (as shown in the center #3 of FIGS. 1, 2 and 3) and makes eating these items on a stick a lot of fun. It makes eating messy items easier, more fun and clean-up is easy. Items on a stick will sit in the cupped portion (shown in FIG. 6) of the apparatus while the stick will go through the center (#3) of the apparatus hanging out below allowing the user to hold the stick exactly as it was designed. At the center of the invention the hole (#3 may have a rubber piece allowing the stick to pass through, creating a tight seal so the melting or flowing substance will not flow through the hole. The flowing substance will remain in the cupped portion (shown in FIG. 6) of the apparatus. On the edge of the cupped portion (shown in FIG. 6) of the apparatus will be various designs (#1 as shown in FIGS. 1, 2 and 3) allowing the item on a stick to create a fun edible item.

This invention relates generally to edible items in a cone (as shown in FIGS. 4 and 5). It can be any shaped cone. The edible items will fit down inside the deep well #3 as shown in FIGS. 4 and 5 of the apparatus. The top (as shown in #2 of FIGS. 4 and 5) of the apparatus will be slightly larger than the bottom (#3) of the apparatus allowing the overflow of the edible item in the apparatus to be contained within the top (#2) portion of the apparatus. A decorative edge adds an element of fun as shown in #1 of the drawings in FIGS. 1, 2 and 3. Any type of edging can be added for an element of fun. The edging can be the petals of a flower (#1 as shown in FIG. 2) and having the edible item in the center (#2)—a flower would be created. The edging can be the scales of a dinosaur (as shown in #1 in FIG. 1), a set of mouse ears, waves of the ocean, lace, or any number of different items. The designer of the individual containers imagination is the limit.

### SUMMARY

Among the several objects of this invention may be noted the provision of an improved novelty item to hold items on a stick or in a cone. The items on a stick would drip into the cupped apparatus. The items in a cone would drip into the top cupped housing of the apparatus. These items would allow the eater of the edible items to remain free from the mess that such an item could create.

### DESCRIPTION OF THE DRAWINGS

FIG. 1 shows dinosaur scales (#1) in a circle surrounding the top edge of FIG. 6. FIG. 1 has a slit in the center (#3) for a stick with an edible item on it. The slit may be raised to create a well with or without a seal for the contents of the edible item (such as frozen foods when they melt) to be contained. The slit maybe flat (even with the bottom of the apparatus) with or without a seal for less runny type edible items (such as food where the condiments or some portion of the food may drip).

FIG. 2 shows flower petals (#1) in a circle surrounding the top edge of FIG. 6. FIG. 2 has a slit in the center (#3) for a stick with an edible item on it. The slit may be raised to create a well with or without a seal for the contents of the edible item (such as frozen foods when they melt) to be contained. The slit maybe flat (even with the bottom of the apparatus) with or without a seal for less runny type edible items (such as food where the condiments or some portion of the food may drip).

FIG. 3 shows sun rays (#1) in a circle surrounding the top edge of FIG. 6. FIG. 3 has a slit in the center (#3) for a stick with an edible item on it. The slit may be raised to create a well with or without a seal for the contents of the edible item (such as frozen foods when they melt) to be contained. The slit maybe flat (even with the bottom of the apparatus) with or without a seal for less runny type edible items (such as food where the condiments or some portion of the food may drip).

FIG. 4 shows a cylinder-shaped apparatus with a top portion (#2) that is a little larger than the bottom portion (#3) of the cylinder-shaped apparatus. This shape is designed to hold an item of similar shape to help avoid a mess or as a decorate piece. The top of the rim will have designs surrounding it similar to those in FIGS. 1, 2 and 3. FIG. 4 shows the well #2 (that is a little larger than the bottom #3) is where the portion of the food that has melted, slid off or fallen off would be housed. The bottom #3 of FIG. 4 is the location where the items being eaten would sit.

FIG. 5 shows a cone-shaped apparatus with a top portion (#2) that is a little larger than the bottom portion (#3) of the cone-shaped apparatus. This shape is designed to hold an item of similar shape to help avoid a mess or as a decorate piece. The top of the rim will have designs surrounding it similar to those in FIGS. 1, 2 and 3. FIG. 5 shows the well #2 (that is a little larger than the bottom #3) is where the portion of the edible item that has melted, slid off or fallen off would be housed. The bottom #3 of FIG. 5 is the location where the edible item being eaten would sit.

FIG. 6 is the side view of FIGS. 1, 2 and 3 and the top (#2) of the side view of FIGS. 4 and 5. This is designed to have a flat slit or round slit in the bottom #3 in FIGS. 1, 2 and 3 where a round or flat stick would go through and is the top (#2) portion of the cone or cylinder bottom (#3) in FIGS. 4 and 5. In FIGS. 1, 2 and 3 it could also have a raised area where the flat/round slit (#3) is located creating a well to better contain liquid in FIGS. 1, 2 and 3.

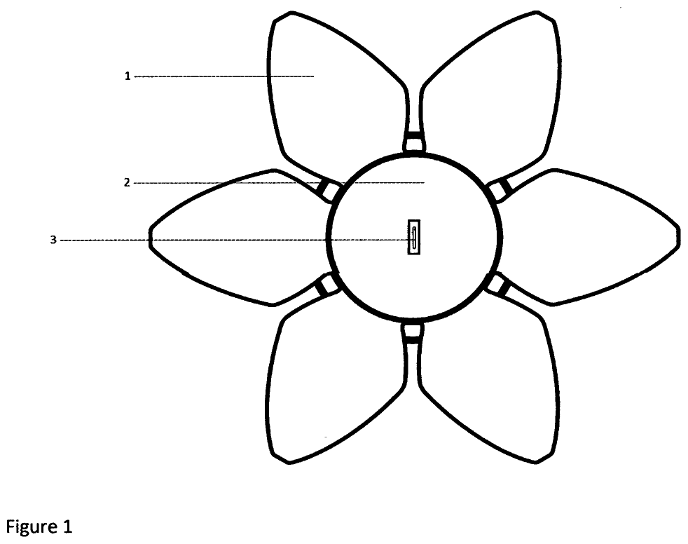

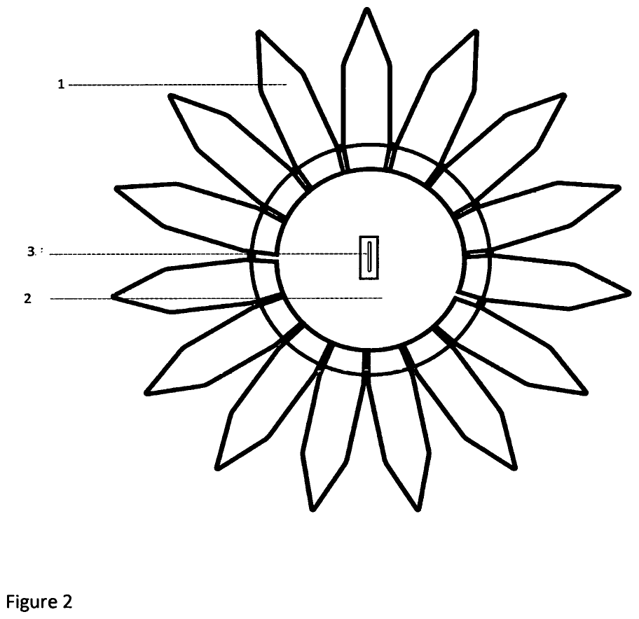

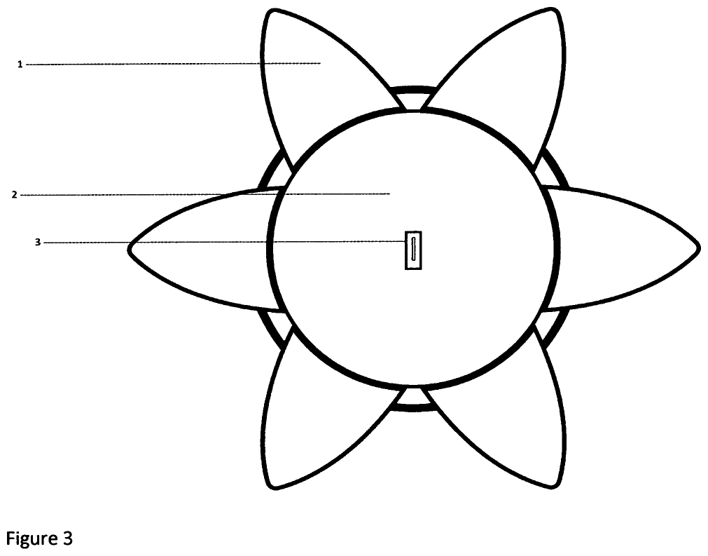

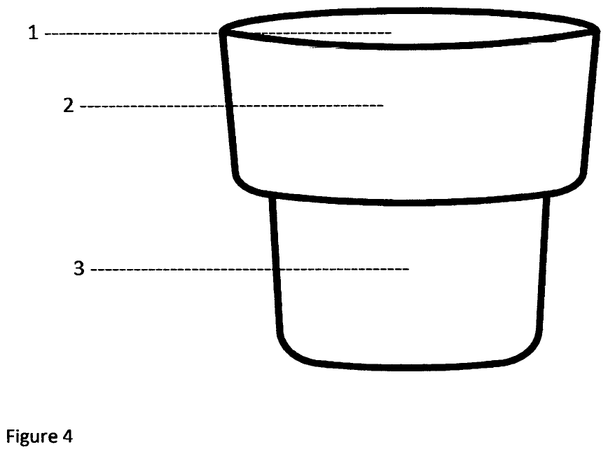

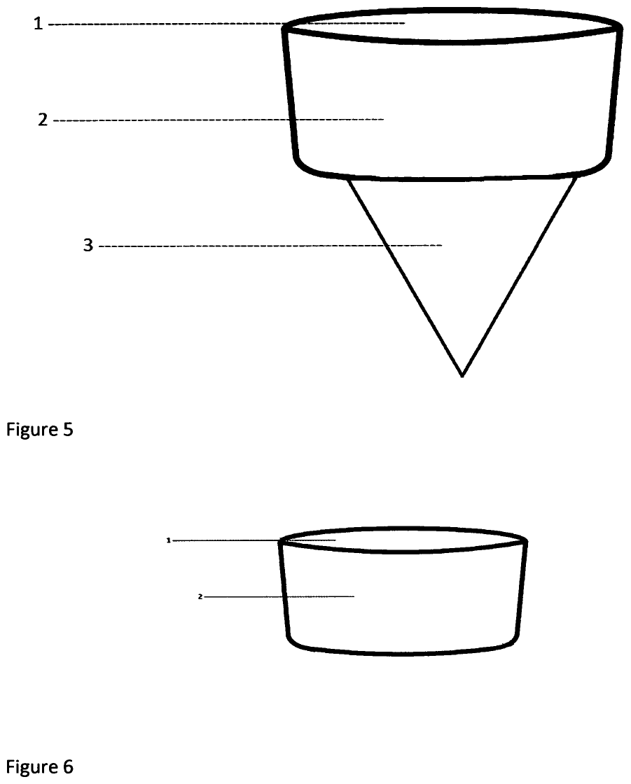

### PATENT CITATIONS

US 20080279992A1 Filing Date: May 7, 2007 Publication Date: Pending (Nov. 13, 2008) Inventor: Michael Kahn, Assignee: GZB Corp, Title: Holder for objects which melt, drip or leaves finger imprints

US 20060127542A1 Filing Date: Dec. 16, 2004 Publication Date: Pending (Jun. 15, 2006) Inventor: David Wachtel, Assignee: David Wachtel, Title: Absorbent popsicle holder

US 20110223292A1 Filing Date: Mar. 12, 2010 Publication Date: Pending (Sep. 15, 2011) Inventor: Julie Kushner, Assignee: Julie Kushner, Title: Frozen confection holder

US 20090040746A1 Filing Date: Aug. 5, 2008 Publication Date: Pending (Feb. 12, 2009) Inventor: Sarid M. Shefet, Assignee: RDI Foods LLC, Title: Novelty stick holders for foods on sticks

US 20130133522A1 Filing Date: Jun. 30, 2011 Publication Date: Mar. 30, 2013 Inventor: Jean-Luc Denisart, Assignee: Nestec SA, Title: Device for adapting a food capsule into a capsule holder

US 20090068324A1 Filing Date: Sep. 6, 2007 Publication Date: Pending (Mar. 12, 2009) Inventor: Sergio Sandoval, Assignee: Sergio Sandoval, Title: Confection holder

US 20120058218A1 Filing Date: Aug. 4, 2011 Publication Date: Pending (Mar. 8, 2012) Inventor: Daniel R. Blondeau, Assignee: Blondeau Daniel R., Title: Frozen confectionery holder

US 20060053592A1 Filing Date: Sep. 13, 2004 Publication Date: Pending (Mar. 16, 2006) Inventor: Aniello Costagliola, Assignee: Aniello Costagliola, Title: Ice cream holder

US 20070259075A1 Filing Date: May 4, 2006 Publication Date: Pending (Nov. 8, 2007) Inventor: Paul Gray, Assignee: Gray Paul C, Title: Confection support holder

US 20030056662A1 Filing Date: Nov. 15, 2002 Publication Date: Pending (Mar. 27, 2003) Inventor: Tom Pritchard, Assignee: Tom Pritchard, Title: Frozen confectionery product and method of manufacture

US 20090004316A1 Filing Date: Jun. 29, 2007 Publication Date: Pending (Jan. 1, 2009) Inventor: Aniello Costagliola, Assignee: Aniello Costagliola, Title: Ice Cream Holder

US 20150060532A1 Filing Date: Aug. 12, 2014 Publication Date: Pending (Mar. 5, 2015) Inventor: Ward J. Goldstein, Assignee: Ward J. Goldstein, Title: Food Product Holder

US 20120205382A1 Filing Date: Feb. 11, 2011 Publication Date: Aug. 16, 2012 Inventor: Mecinna Price, Assignee: Mecinna Price, Title: Frozen food item holder

U.S. Pat. No. 9,027,807B2 Filing Date: May 12, 2015 Publication Date: May 12, 2015 Inventor: Elliot Zachary Kampas, Assignee: Elliot Zachary Kampas, Title: Wearable beverage container holder

US 20070196545A1 Filing Date: Mar 22, 2005 Publication Date: Pending (Aug. 23, 2007) Inventor: Ulla Prazeres, Assignee: SOMME DANELA, Title: Holding Device For Ice-Cream Cones And Method For The Use Thereof

U.S. Pat. No. 6,221,409B1 Filing Date: Aug. 26, 1999 Publication Date: Apr. 24, 2001 Inventor: Jorge Bueno Ceresuela, Assignee: Nestec SA, Title: Rotatable frozen confectionary product

US 20020029697A1 Filing Date: Sep. 7, 2001 Publication Date: Pending (Mar. 14, 2002) Inventor: Perry Oshio, Assignee: Perry Oshio, Title: Frozen dessert holder

1. A fun decorative way to eat foods on a stick or in a cone without the mess. The device helps to keep items inside the housing and off the individuals hands that is eating the food.

2. A unique way to transform your food item into something fun—such as a novelty item.

3. A way to upsell a vendor's current merchandise.

4. They can be made in a variety of shapes such as a flower, baseball, football, ballerina feet, trees, etc. The individuals imagination is limitless.
